(19) United States
(12) Patent Application Publication
(10) Pub. No.: US 2013/0340592 A1
(43) Pub. Date: Dec. 26, 2013

(54) DETACHABLE AND FOLDABLE INTEGRATED ORGAN AND PROCESS FOR MANUFACTURING KEYBOARD THEREOF

(71) Applicant: Jun Yao, Shenzhen (CN)

(72) Inventor: Jun Yao, Shenzhen (CN)

(21) Appl. No.: 13/604,852

(22) Filed: Sep. 6, 2012

(30) Foreign Application Priority Data
Jun. 21, 2012 (CN) 201210207981.8

(51) Int. Cl. G10B 1/02; B32B 37/02

(52) U.S. Cl. 84/354; 156/245

(57) ABSTRACT

A detachable and foldable integrated organ includes a keyboard and a host mounted detachably thereon, the keyboard includes a flexible substrate on which flexible keys are provided, a flexible circuit board is provided between the substrate and the keys to generate an electrical signal corresponding to an action of the keys in response to the action, and an elastic arm for enhancing the resiliency of the keys are provided between the flexible circuit board and the key; the host is electrically connected to the flexible circuit board and adapted to process the electrical signal corresponding to the action of the key, and drive a speaker to sound. The detachable design between host and keyboard results in a more flexible and higher productivity; the keyboard is made of flexible material and thus is foldable, which can effectively reduce the volume of the organ and make it easy to carry.

### TECHNICAL FIELD

The present invention relates to the field of musical instrument technologies, and particularly, to a detachable and foldable integrated organ and the process for manufacturing the keyboard thereof.

### TECHNICAL BACKGROUND

The organ is a traditional musical instrument for musical performance. An electronic organ, which is one of electronic instruments, amplifies an audio source signal through a semiconductor integrated circuit and produces sound by a speaker, and thus is advantageous for freely adjustable volume, wide diapason, rich harmonies, etc.

Chinese patent publication CN 201859646U discloses a special electronic organ, which is formed of a body, a control area, speakers, keys, and Light Emitting Diodes (LEDs) for the keys. The control area is located in the middle of the front end of the body, two speakers are symmetrically fixed at two side ends of the body, the keys are distributed on the proximal end of the body, and the LEDs are fixed within the keys. A musical notation corresponding to a key is indicated by an LED. In this way, the rhythm of the musical notations can be shown through flashing of the LEDs, in order to facilitate the correct pressing of the keys by students. Since it becomes easier for the students to grasp the proper playing skills of the rhythm due to the fact that the students can visually, tactilely and acoustically feel the rhythm, the training effectiveness is obviously enhanced. However, such organ is disadvantageous for its large overall packaging volume, and therefore is not easy to carry and store.

In order to reduce the size of the organ and carry it easily, an electronic organ which can be crimped is provided in the market to meet the requirement mentioned above. For example, the Chinese patent document CN 2837982 Y disclosed a flexible electronic organ that may be crimped and placed in expansion, which includes a circuit of the electronic organ, a keyboard, and a control box for controlling the function of the organ. However, the drawback of such electronic organ lies in that it is not easy to manufacture and assemble and structural flexibility is not enough, because the keyboard and the control box are connected fixedly.

Also, the Chinese patent document CN 2741143 Y discloses a foldable electronic organ, which includes a host and a keyboard installed on the host. The keyboard of the electronic organ is made of flexible material, and thus can be folded as desired for the purpose of easy carrying during the travelling. However, such organ has drawbacks as follows: (1) the host and the keyboard are fixedly connected so that the production and the process are complicate and productivity is low, resulting insufficient flexibility of the overall structure of the electronic organ; and (2) the distance between the keys and the circuit board is relatively short, leading to the lack of resiliency of the keys, and eventually leading to the low sensitivity of the keys.

### SUMMARY OF THE INVENTION

An object of the invention is intended to solve the problem mentioned above by proposing a detachable and foldable integrated organ. The organ is easy to manufacture and assemble due to its separable structural design, so that the productivity is improved; on the other hand, by using the foldable design, the volume can be reduced so that it is easy to carry and store.

The invention also proposes a process for manufacturing the organ keyboard. The process is advantageous for its simplicity and is easy for automated batch production.

The object is achieved with technical solutions below.

A detachable and foldable integrated organ, includes:

a keyboard which includes a flexible substrate, on which flexible keys are provided, a flexible circuit board is provided between the substrate and the keys to generate an electrical signal corresponding to an action of the key in response to the action, and an elastic arm for enhancing the resiliency of the key is provided between the flexible circuit board and the key, and;

a host which is mounted detachably on the keyboard, and adapted to process the electrical signal corresponding to the action of the key, and drive a speaker to sound.

Further, the host and the keyboard are arranged apart from one another, and the host and the flexible circuit board are in communication with each other through a wireless communication technology.

Furthermore, the wireless communication technology is Bluetooth or wireless local area network technology, or other wireless communication technologies known by the skills in the art.

Further, the host and the keyboard are arranged in contact with one another, and the host and the flexible circuit board are in communication with each other through a wireline communication technology.

Furthermore, the host and the keyboard are electrically connected through a slot, or male and female extension sockets, or conductive lines.

Preferably, the flexible circuit board includes a first conductive film having conductive lines and a second conductive film having conductive lines, the second conductive film is arranged against the internal wall of the substrate, the first conductive film is placed on the side of the second conductive film that is away from the substrate, the elastic arm is provided between the first conductive film and each of keys, and an insulated barrier corresponding to contour of each of keys is provided between the first conductive film and the second conductive film, in order to enable the selective connection of lines of the first conductive film and those of the second conductive film.

Furthermore, conductive lines on the first conductive film and the second conductive film are in the form of grid lines, protruding insulated isolation points are provided within the grids of the grid lines on the second conductive film, to prevent the short circuit between the first conductive film and the second conductive film.

Furthermore, projections are provided on the side of the key adjacent to the first conductive film, with the projections being arranged alternately with the isolation points. When the key is pressed, the projections can avoid the isolation points, thus improving the sensitivity of the key.

Furthermore, the projections are cylindrically shaped.

Furthermore, the substrates of the first conductive film and the second conductive film are made of PET material, and silver paste lines and carbon paste lines are printed on the substrates.

Further, a plurality of keys are provided.

Preferably, the number of the keys is sixty-one or eighty-eight.

Further, the host and/or the keyboard may include a power supply (e.g. a cell) or be connected externally to a power supply. The host and/or the keyboard are also provided with a plurality of function keys, to have functions of memory, volume control, power switch on or off, external pedal, video output, USB, MIDI, etc., so that the host and/or the keyboard can meet various needs through the numerous functions.

A process for manufacturing an organ keyboard, including a step of producing the keyboard, a step of producing conductive films, and a step of assembling the conductive films and the keyboard, wherein

the step of producing the keyboard includes:

a step of mixing and kneading of silica gel, in which ingredients are prepared by weight ratios and include 100 parts of dimethyl silicone crude rubber, 0.5 to 3 parts of dimethyl tertiary butyl peroxide hexane, 35 to 45 parts of precipitated white carbon black, and 8 parts of hydroxy silicone oil, then, the ingredients are mixed internally by a kneader, mixed by an open mill and a vulcanizer and packaged, and finally, cut into sheets of silica gel according to the desired standard thickness;

a step of molding of silica gel, in which in mold-locked production employing a two-layer die, the silica gel is fed to the lower-layer of the die and vulcanized at a vulcanization temperature of 170±10° C. and the pressure of 200±5 kg/cm² for 80±3 seconds, and then excessive burrs are removed from the keys of silica gel after the vulcanization; and

a step of surface treatment, in which a screen and a screen printing clamp are positioned on a screen printing machine, then the keys of silica gel are placed on the screen printing clamp for surface screen printing, and then dried using the elevated temperature tunnel with a temperature of 190±10° C. for 10 to 15 minutes;

the step of producing conductive film includes:

a step of baking of the substrate, in which the PET substrate of the conductive film is baked within an oven at a temperature of 160±10° C. for 75 to 85 minutes;

a step of screen printing of lines, in which firstly, the PET substrate is put on the screen printing machine and positioned with respect to screen, the screen printing of shielding nets of the conductive film is screen printed by using silver paste or carbon paste, and dried in a drying tunnel having a temperature of 110±5° C. for 3 to 5 minutes, then, main lines is are screen printed by using silver paste or carbon paste and dried in the drying tunnel having the a temperature of 110±5° C. for 3 to 5 minutes; subsequently, bridges (i.e. intersections in the lines) are screen printed with insulating oil, and subjected to solidification in a UV tunnel with a temperature of 80±5° C. for 20 seconds; then, the keys and jumpers are screen printed by using the silver paste or the carbon paste and dried in the drying tunnel with a temperature of 10±5° C. for 3 to 5 minutes; and then the isolation points and barriers are screen printed and subjected to solidification in the UV tunnel with a temperature of 80±5° C. for 20 seconds; and finally the screen printed conductive film is dried in the oven at a temperature of 160±10° C. for 75 to 85 minutes; and

a step of assembling conductive films, in which firstly, the upper and lower conductive films are assembled in alignment and bonded by using an ultrasonic machine or brand iron, and then perforated using a computer-controlled automatic punch, and after that the conductive films are trimmed in shape by a stamping machine using the stamping die, here the stamping die used may be a metal die.

Furthermore, in the step of surface treatment, the surfaces of the keys are hardened, by compounding the epoxy layer on the surfaces of the keys, or by treating the surfaces of keys with the silica gel treatment before compounding the epoxy layer, after the screen printing of the keys is finished, so that the handle of the keys is better.

Compared with traditional technology, the present invention has the following effects.

1. The detachable design between the host and the keyboard results in a more flexible structure of the organ and higher productivity;

2. The keyboard is made of flexible material and thus is foldable, which can effectively reduce the volume of the organ and make it easy to carry;

3. The Elastic arms are provided between the keys and the conductive film, which can enhance the resilience of the keys;

4. Isolation points are provided between the two conductive films, which can effectively prevent the short-circuit;

5. The projections are provided at the bottom of keys, which can effectively improve the sensitivity of the keys.

### BRIEF DESCRIPTION OF THE DRAWINGS

FIG. 1 is a schematic diagram showing the structure of the detachable and foldable integrated organ of a first embodiment of the invention;

FIG. 2 is a local sectional schematic diagram for the keyboard of the organ shown in FIG. 1;

FIG. 3 is a schematic diagram of the bottom view of the keys shown in FIG. 2;

FIG. 4 is a schematic diagram of the front structure of the first conductive film shown in FIG. 2;

FIG. 5 is a schematic diagram of the front structure of the second conductive film shown in FIG. 2;

FIG. 6 is a schematic diagram of the back structures of the first conductive film and the second conductive film shown in FIG. 2;

FIG. 7 is a schematic diagram showing the state of the detachable and foldable integrated organ, where the host and the keyboard are separated, according to an embodiment of the invention.

### REFERENCE LIST

1: keyboard; 2: host; 3: connecting component; 11: key; 12: substrate; 13: second conductive film; 14: first conductive film; 15: elastic arm; 16: isolation point; 17: barrier; 18: cylinder; 19: grid line; 20: function key; 31: first connector.

The present invention is further described in detail below. However, the following examples are merely illustrative examples of the present invention, which do not represent or limit the scope of the present invention. The scope of the present invention is defined by the appended claims.

### DETAILED DESCRIPTION OF THE INVENTION

In order to explain the present invention and facilitate the understanding of the technical solution of the present invention, typical but non-limiting embodiments of the invention are as follows:

### A First Embodiment

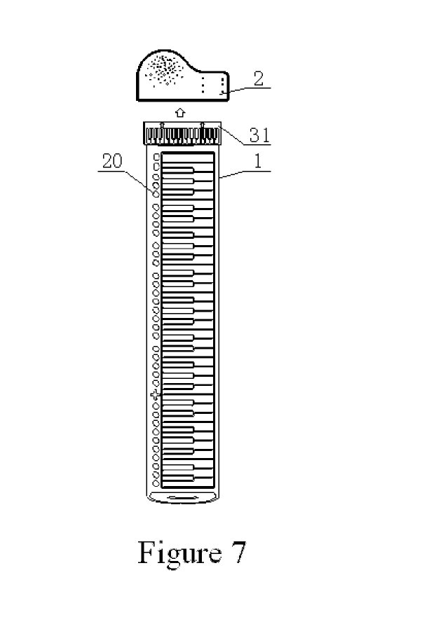

As shown in FIGS. 1 and 7, a detachable and foldable integrated organ includes a keyboard 1 and a host 2. The keyboard 1 is mounted detachably to the host 2 through a connecting component 3. By the detachable design, the structure of the organ is more flexible and the production is more efficient.

In this embodiment, the connecting components 3 includes a first connector 31 provided on the side of the keyboard and a second connector provided on the side of the host. The first connector is in the form of a plug, and the second connector is in the form of a slot which matches the plug, to achieve the connection between the host and the keyboard.

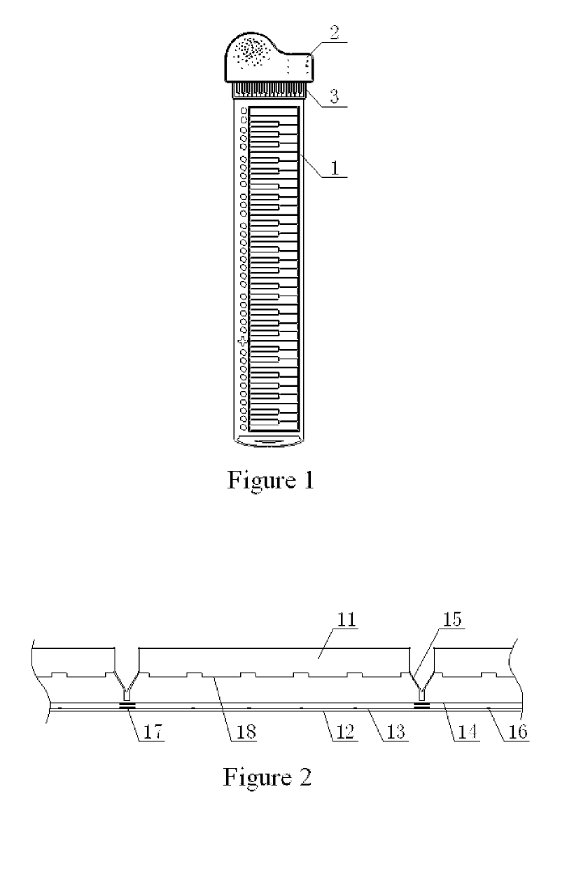

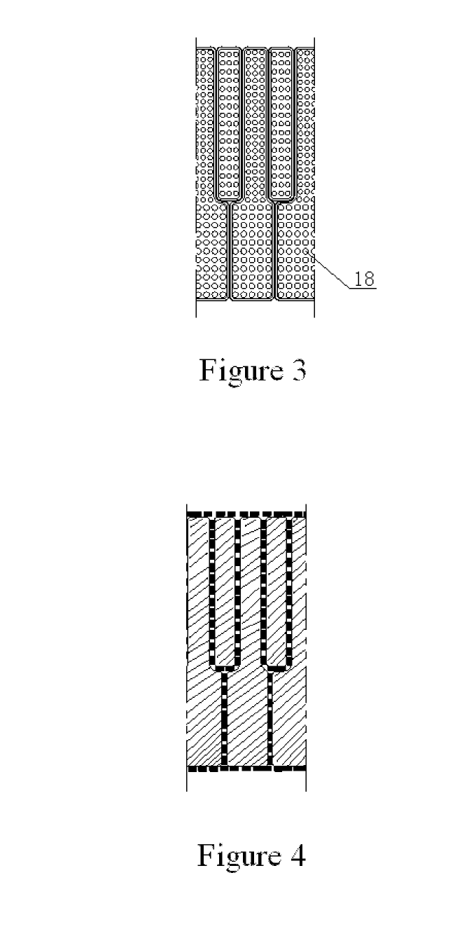

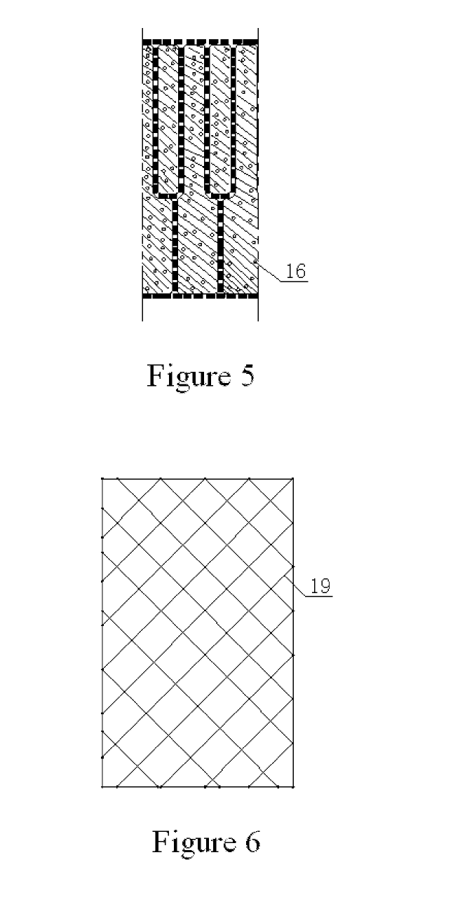

Further with reference to FIGS. 2-6, the keyboard 1 includes a substrate 12 on which sixty-one keys 11 are provided. Two conductive films, namely a first conductive film 14 and a second conductive film 13, are provided between the keys 11 and the substrate 12. The first conductive film 14 is provided close to the keys 11, and the second conductive film 13 is provided close to the substrate 12. An elastic arm 15 corresponding to the contour of each key is provided between the first conductive film 14 and the keys 11, and is used to raise the key for the purpose of improving the resilience of the key. Conductive lines are printed on the front sides of both the first conductive film 14 and the second conductive film 13, and the two front sides are arranged opposite to one another. The lines are in the form of grids. Insulated barriers 17, which actually function as switches, are provided between the first conductive film 14 and the second conductive film 13. When the key 11 is not pressed, the lines of the first conductive film 14 and those of the second conductive film 13 are not connected; in contrary, when the key 11 is pressed, the lines of both films 14 and 13 are connected. On the front side of the second conductive film 13, a number of protruding insulated isolation points 16 are provided to prevent the short circuit between the first conductive film 14 and the second conductive film 13. In order to further improve the sensitivity of the keys, the back side of the key is provided with a number of cylinders 18. The cylinders 18 and the isolation points 16 are alternately arranged. When the key is pressed, the cylinders 18 can avoid the isolation points 16 effectively, so that the lines on the first conductive film and the lines on the second conductive film are connected. Both of the back sides of the first conductive film and the second conductive film are provided with grid lines 19 used for grounding for the purpose of shielding and anti-interference.

The keyboard of the organ is made of silica gel using a production method including the steps of mixing and kneading of silica gel, molding of silica gel and surface screen printing.

In the step of mixing and kneading of silica gel, ingredients are prepared by weight ratios and include 100 parts of crude rubber of dimethyl silicone, 0.5 to 3 parts of dimethyl tertiary butyl peroxide hexane, 35 to 45 parts of precipitated white carbon black, and 8 parts of hydroxy silicone oil, then the ingredients are mixed internally by a kneader, mixed by an open mill and a vulcanizer and packaged, and finally cut into sheets of silica gel according to the desired standard thickness. In the step of molding of silica gel, in mold-locked production employing a two-layer die, the silica gel is fed to the lower-layer of the die and vulcanized at a vulcanization temperature of 170±10° C. and the pressure of 200±5 kg/cm² for 80±3 seconds, and then excessive burrs are removed from the keys of silica gel after the vulcanization. In the step of surface screen printing, firstly, a screen and a screen printing clamp are positioned on a screen printing machine, then the keys of silica gel are placed on the screen printing clamp for surface screen printing, and then dried using the elevated temperature tunnel of a temperature of 190±10° C. for 10 to 15 minutes; after the screen printing is finished, the surfaces of the keys are hardened by means of compounding an adhesive-dripping layer on the surfaces, or by compounding a plastic layer on the surfaces of the keys after treating the surfaces by the silica gel processing agent, so that the experience on the resilience of the keys is improved. Thus produced keyboard can be crimped and folded structurally.

The substrate of the conductive film is made of PET (Polyethylene Terephthalate) material, and silver paste lines are printed on the substrate by a process including steps of baking of the substrate, screen printing of lines, and assembly of conductive films. In the step of baking of the substrate, the PET substrate of the conductive film is baked within an oven at a temperature of 160±10° C. for 75 to 85 minutes. In the step of screen printing of lines, firstly the PET substrate is put on the screen printing machine and positioned with respect to the screen, subsequently a shielding net of the conductive film is screen printed by using silver paste or carbon paste and dried in a drying tunnel having a temperature of 110±5° C. for 3 to 5 minutes; then, main lines are screen printed by using silver paste or carbon paste and dried in the drying tunnel having a temperature of 110±5° C. for 3 to 5 minutes; subsequently, bridges (i.e. intersections in the lines) are screen printed with insulating oil and subjected to solidification in a UV tunnel with a temperature of 80±5° C. for 20 seconds; then, the keys and jumpers are screen printed by using the silver paste or the carbon paste, and dried in the drying tunnel with a temperature of 110±5° C. for 3 to 5 minutes; and then the isolation points and barriers are screen printed and subjected to solidification in the UV (Ultraviolet) tunnel with a temperature of 80±5° C. for 20 seconds; and finally the screen printed conductive film is dried in an oven at a temperature 160±10° C. for 75 to 85 minutes. Please be noted that the steps above can be repeated or omitted according to the actual conditions. In the step of assembly of conductive film, firstly the upper and lower conductive films are assembled in alignment and bonded by using an ultrasonic machine or brand iron, and then perforated using a computer-controlled automatic punch, and after that the conductive films are trimmed in shape by a stamping machine using the stamping die.

With the use of a number of function keys 20 provided with on the keyboard, the power may be switched on by a power switch. When a key is pressed, the lines of the first conductive film and the lines of the second conductive film are connected, the action of the key is converted into the corresponding electrical signal to be sent to the host for processing, and then driving the speaker to sound.

### A Second Embodiment

A detachable and foldable integrated organ includes a keyboard and a host which are arranged apart from each other, and the signal transmission between the keyboard and the host is based on Bluetooth technology.

The keyboard includes a substrate on which eighty-eight keys are provided. Two conductive films, namely a first conductive film and a second conductive film, are provided between the keys and the substrate. The first conductive film is provided close to the keys, and the second conductive film is provided close to the substrate. An elastic arm corresponding to the contour of each key is provided between the first conductive film and the keys, and is used to raise the key for the purpose of improving the resilience of the key. Conductive lines are printed on both of the front sides of the first conductive film and the second conductive film, and the two front sides are set opposite to one another. The lines are in the form of grids. Insulated barriers, which actually function as switches, are provided between the first conductive film and the second conductive film. When the key is not pressed, the lines of the first conductive film and those of the second conductive film are not connected; in contrary, when the key is pressed, the lines of the first and second films are connected. On the front side of the second conductive film, a number of protruding insulated isolation points are provided to prevent the short circuit between the first conductive film and the second conductive film. In order to further improve the sensitivity of the keys, the back side of the key is provided with a number of cylinders. The cylinders and the isolation points are alternately arranged. When the key is pressed, the cylinders can avoid isolation points effectively, so that the lines on the first conductive film and the lines on the second conductive film are connected. Both of the back sides of the first conductive film and the second conductive film are provided with grid lines used for grounding for the purpose of shielding and anti-interference.

In use, the power may be switched on by a power switch. When a key is pressed, the lines of the first conductive film and the lines of the second conductive film are connected, to obtain an audio signal, and the audio signal is transmitted by a transmission module provided on the keyboard and received by a receiving module provided on the host for processing, and then drives a speaker to sound.

### A Third Embodiment

A detachable and foldable integrated organ includes a keyboard and a host, an interface for connection is provided on each of the keyboard and the host so that the keyboard and the host may be connected by a connection line.

The keyboard includes a substrate on which eighty-eight keys are provided. Two conductive films, namely a first conductive film and a second conductive film, are provided between the keys and the substrate. The first conductive film is provided close to the keys, and the second conductive film is provided close to the substrate. An elastic arm corresponding to the contour of each key is provided between the first conductive film and the keys, and is used to raise the key for the purpose of improving the resilience of the key. Conductive lines are printed on both of the front sides of the first conductive film and the second conductive film, and the two front sides are set opposite to one another. The lines are in the form of grids. Insulated barriers, which actually function as switches, are provided between the first conductive film and the second conductive film. When the key is not pressed, the lines of the first conductive film and those of the second conductive film are not connected; in contrary, when the key is pressed, the lines of the first and second films are connected. On the front side of the second conductive film, a number of protruding insulated isolation points are provided to prevent the short circuit between the first conductive film and the second conductive film. In order to further improve the sensitivity of the keys, the back side of the key is provided with a number of cylinders. The cylinders and the isolation points are alternately arranged. When the key is pressed, the cylinders can avoid isolation points effectively, so that the lines on the first conductive film and the lines on the second conductive film are connected. Both of the back sides of the first conductive film and the second conductive film are provided with grid lines used for grounding for the purpose of shielding and anti-interference.

In use, the power may be switched on by a power switch. When a key is pressed, the lines of the first conductive film and the lines of the second conductive film are connected to obtain an audio signal, and the audio signal is sent to the host for processing through the connection line, to drive the speaker to sound.

The detailed structural features and manufacturing methods of the present invention are illustrated above, however, the present invention is not limited to the detailed structural features and manufacturing methods mentioned above, that is, the implement of the present invention is not necessarily limited to the above detailed structural features and manufacturing methods. Those skilled in the art should understand that any improvements to the present invention, the equivalent substitutions to the parts used in present invention, additional auxiliary parts, and the selection for the specific implementations shall fall within the scopes of the present invention.

1. A detachable and foldable integrated organ, characterized by comprising:
a keyboard which includes a flexible substrate on which flexible keys are provided, a flexible circuit board is provided between the keys and the substrate to generate an electrical signal corresponding to an action of the key in response to the action, and an elastic arm for enhancing the resiliency of the key is provided between the flexible circuit board and the key, and;
a host which is mounted detachably on the keyboard and adapted to process the electrical signal corresponding to the action of the key and drive a speaker to sound.

2. The organ of claim 1, characterized in that the host and the keyboard are arranged apart from one another, and the host and the flexible circuit board are in communication with each other through a wireless communication technology.

3. The organ of claim 1, characterized in that the host and the keyboard are arranged in contact with one another, and the host and the flexible circuit board are in communication with each other through a wireline communication technology.

4. The organ of claim 1, characterized in that the flexible circuit board includes a first conductive film having conductive lines and a second conductive film having conductive lines, the second conductive film is arranged against the internal wall of the substrate, the first conductive film is placed on the side of the second conductive film that is away from the substrate, the elastic arm is provided between the first conductive film and each of the keys, and an insulated barrier corresponding to contour of each of the keys is provided between the first conductive film and the second conductive film, in order to enable the selective connection of the lines of the first conductive film and those of the second conductive film.

5. The organ of claim 3, characterized in that the host and the keyboard are connected through a slot, or male and female extension sockets, or connection lines, and the host and the flexible circuit board are electrically connected through the conductive lines.

6. The organ of claim 4, characterized in that the conductive lines on the first conductive film and the second conductive film are in the form of grid lines, protruding insulated isolation points are provided within grids of the grid lines on the second conductive film to prevent the short circuit between the first conductive film and the second conductive film, and projections are provided on the side of the key adjacent to the first conductive film, with the projections being arranged alternately with the isolation points.

7. The organ of claim 6, characterized in that the substrates of the first conductive film and the second conductive film are made of PET material, and silver paste lines and carbon paste lines are printed on the substrates.

8. The organ of claim 1, characterized in that the keyboard is provided with a plurality of keys, and the host and/or the keyboard are selectively provided with a function key.

9. A process for manufacturing an organ keyboard, characterized by comprising a step of producing the keyboard, a step of producing conductive films, and a step of assembling the conductive films and the keyboard, wherein
the step of producing the keyboard includes:
a step of mixing and kneading of silica gel, in which ingredients are prepared by weight ratios and mixed internally by a kneader, then mixed by an open mill and a vulcanizer and packaged, and finally cut into sheets of silica gel according to the desired standard thickness;
a step of molding of silica gel, in which, in mold-locked production employing a two-layer die, the silica gel is fed to the lower-layer die and vulcanized, and then excessive burrs are removed from keys of silica gel after the vulcanization; and
a step of surface treatment, in which a screen and a screen printing clamp are positioned on a screen printing machine, then the keys of silica gel are placed on the screen printing clamp for surface screen printing and then dried using an elevated temperature tunnel;
the step of producing conductive films includes:
a step of baking of the substrate, in which the substrate of the conductive film is baked within an oven;
a step of screen printing of lines, in which firstly the substrate is put on the screen printing machine and positioned with respect to the screen, a shielding net of the conductive film is screen printed using silver paste or carbon paste and dried in a drying tunnel, then main lines are screen printed using silver paste or carbon paste and dried, and subsequently, bridges, i.e. intersections in the lines, are screen printed with insulating oil and solidified in a UV tunnel, then the keys and jumpers are screen printed using silver paste or carbon paste and dried in the drying tunnel, then isolation points and bathers are screen printed and solidified in the UV tunnel, and finally the screen printed conductive films are dried; and
the step of assembling conductive films, in which a first conductive film and a second conductive film are assembled in alignment and perforated, and then trimmed in shape.

10. The process of claim 9, characterized in that in the step of the surface treatment, the surfaces of the keys are hardened after screen printing.
